(19) United States
(12) Patent Application Publication
(10) Pub. No.: US 2025/0219159 A1
(43) Pub. Date: Jul. 3, 2025

(54) ELECTRODES INCLUDING POSITIVE TEMPERATURE COEFFICIENT (PTC) MATERIALS

(71) Applicant: GM GLOBAL TECHNOLOGY OPERATIONS LLC, Detroit, MI (US)

(72) Inventors: Yan WU, Shanghai (CN); Dewen Kong, Shanghai (CN); Melyuan Wu, Shanghai (CN); Jingyuan Liu, Shanghai (CN); Haijing Liu, Shanghai (CN)

(21) Appl. No.: 18/418,787

(22) Filed: Jan. 22, 2024

(30) Foreign Application Priority Data
Dec. 27, 2023 (CN) 202311826626.3

(51) Int. Cl. H01M 10/42; H01M 4/02; H01M 4/36; H01M 4/62; H01M 50/581

(52) U.S. Cl. CPC H01M 10/4235; H01M 4/366; H01M 4/62; H01M 50/581; H01M 2004/021; H01M 2200/106

(57) ABSTRACT

An electrode for a battery cell includes a current collector and an active material layer arranged on the current collector. In some examples, the active material layer includes an active material, a conductive additive, a positive temperature coefficient (PTC) material, and a binder. In other examples, the active material layer includes active material with an outer coating including PTC material. In other examples, a PTC layer is arranged on the active material layer.

### CROSS-REFERENCE TO RELATED APPLICATIONS

This application claims the benefit of Chinese Patent Application No. 202311826626.3, filed on Dec. 27, 2023. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to electrodes and methods for manufacturing electrodes of battery cells.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

Battery cells include cathode electrodes, anode electrodes, and separators. The cathode electrodes include a cathode active material layer arranged on a cathode current collector. The anode electrodes include an anode active material layer arranged on an anode current collector.

### SUMMARY

An electrode for a battery cell includes a current collector and an active material layer arranged on the current collector. The active material layer includes an active material, a conductive additive, a positive temperature coefficient (PTC) material, and a binder.

In other features, the active material is in a range from 80 wt % to 99 wt %, the PTC material is in a range from 0.5 wt % to 20 wt %, the conductive additive is in a range from 0.5 wt % to 20 wt %, and the binder is in a range from 0.5 wt % to 10 wt %. The active material is in a range from 80 wt % to 99 wt %, the PTC material is in a range from 1 wt % to 5 wt %, the conductive additive is in a range from 0.5 wt % to 20 wt %, and the binder is in a range from 0.5 wt % to 10 wt %.

In other features, the PTC material has a Curie temperature in a range from 80° C. to 200° C. The PTC material has a Curie temperature in a range from 80° C. to 140° C.

In other features, the PTC material includes an inorganic material selected from a group consisting of metal oxide, BaTiO₃, V₂O₅, and combinations thereof. The PTC material includes an organic material selected from a group consisting of polymethyl methacrylate (PMMA) or polydimethylsiloxane (PDMS).

In other features, the PTC material is doped with one or more elements selected from a group consisting of lanthanum (La), cerium (Ce), antimony (Sb), yttrium (Y), tungsten (W), titanium (Ti), tantalum (Ta), niobium (Nb), cobalt (Co), chlorine (Cl), iodine (I), bromine (Br), and combinations thereof.

An electrode for a battery cell comprises a current collector and an active material layer arranged on the current collector. The active material layer includes an active material including an outer coating layer comprising a positive temperature coefficient (PTC) material, a conductive additive, and a binder.

In other features, the PTC material has a Curie temperature in a range from 80° C. to 200° C. The PTC material has a Curie temperature in a range from 80° C. to 140° C. The PTC material includes an inorganic material selected from a group consisting of metal oxide, BaTiO₃, V₂O₅, and combinations thereof. The PTC material includes an organic material selected from a group consisting of polymethyl methacrylate (PMMA) or polydimethylsiloxane (PDMS). The outer coating layer has a thickness in a range from 50 nm to 2 μm. The outer coating layer has a thickness in a range from 200 nm to 500 nm.

An electrode for a battery cell includes a current collector and an active material layer arranged on the current collector. The active material layer includes an active material, a conductive additive, and a binder. A positive temperature coefficient (PTC) layer is arranged on the active material layer and includes a PTC material.

In other features, the PTC material has a Curie temperature in a range from 80° C. to 200° C. The PTC material has a Curie temperature in a range from 80° C. to 140° C.

The PTC material includes an inorganic material selected from a group consisting of metal oxide, BaTiO₃, V₂O₅, and combinations thereof. The PTC material includes an organic material selected from a group consisting of polymethyl methacrylate (PMMA) or polydimethylsiloxane (PDMS).

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross sectional view of a battery cell including anode electrodes, cathode electrodes and separators according to the present disclosure;

FIG. 2 is a side cross sectional view of a cathode electrode including a PTC coated cathode active material according to the present disclosure;

FIG. 3 is a side cross sectional view of an anode electrode including a PTC coated anode active material according to the present disclosure;

FIG. 4 is a side cross sectional view of a particle of active material with a PTC coating according to the present disclosure;

FIG. 5 is a side cross sectional view of a cathode electrode including a cathode active material layer including PTC material according to the present disclosure;

FIG. 6 is a side cross sectional view of an anode electrode including an anode active material layer including PTC material according to the present disclosure;

FIG. 7 is a side cross sectional view of a cathode electrode including a PTC layer according to the present disclosure;

FIG. 8 is a side cross sectional view of an anode electrode including a PTC layer according to the present disclosure;

FIG. 9A to 9D are flowcharts of method for manufacturing an electrode including an active material layer including PTC material according to the present disclosure;

FIG. 10A is a graph of heat flow as a function of temperature for battery cells with and without PTC material according to the present disclosure;

FIGS. 10B and 10C are graphs demonstrating results of a formation cycle check and C-rate check for battery cells with and without PTC material according to the present disclosure.

In the drawings, reference numbers may be reused to identify similar and/or identical elements.

### DETAILED DESCRIPTION

While battery cells according to the present disclosure are described in the context of vehicles, the battery cells can be used in other applications such as stationary applications.

Battery cells can experience rapid temperature increases when triggered by penetration of a battery cell enclosure (e.g., by a nail or other sharp object), thermal propagation, and/or short circuits. The rapid temperature increase can cause separator shrinkage, melting, and additional short circuits. As can be appreciated, reducing heat generation due to short circuits can be used to prevent thermal runaway.

The present disclosure relates to electrodes including a positive temperature coefficient (PTC) material that experiences a significant increase in resistance at a Curie temperature in response to increased battery cell temperature. For example, the PTC material can be used as a coating on particles of the active material, as PTC particles mixed with the active material layer, and/or in a PTC layer between the active material layer and an adjacent separator layer.

As can be appreciated, the resistance of the PTC material significantly increases when the temperature of the battery cell increases above the Curie temperature. For example, the PTC material may include BaTiO₃ having a resistance of ˜10¹ ohms up to about 100° C. and then increases rapidly thereafter to ˜10⁵ ohms at 175° C. In some examples, the Curie temperature of the PTC material is adjusted or lowered by doping or using an additive to a temperature less than a melting temperature of the separator (e.g., less than 150° C.).

In some examples, the resistance of the PTC material increases sufficiently in response to the increased temperature to create an effective open circuit. When the cell temperature increases above the Curie temperature of the PTC material, the resistance of the battery cell increases rapidly. The increased resistance reduces current flow to prevent further temperature increases and/or suppresses or prevents short circuits.

Referring now to FIG. 1, a battery cell 10 includes C cathode electrodes 20, A anode electrodes 40, and S separators 32 arranged in a predetermined sequence in a battery cell stack 12, where C, S and A are integers greater than zero. The battery cell stack 12 is arranged in an enclosure 50. The C cathode electrodes 20-1, 20-2, . . . , and 20-C include cathode active material layers 24 arranged on one or both sides of a cathode current collector 26.

In some examples, the A anode electrodes 40 and the C cathode electrodes 20 exchange lithium ions during charging/discharge. The A anode electrodes 40-1, 40-2, . . . , and 40-A include anode active material layers 42 arranged on one or both sides of the anode current collectors 46. In some examples, the cathode active material layers 24 and/or the anode active material layers comprise a coating or self-standing film including one or more active materials, one or more conductive additives, and/or one or more binder materials that are cast or laminated to the current collectors. The cathode electrodes and/or the anode electrodes incorporate a positive temperature coefficient (PTC) material as will be described further below.

In some examples, the cathode current collector 26 and/or the anode current collector 46 comprise metal foil, metal mesh, perforated metal, 3 dimensional (3D) metal foam, and/or expanded metal. In some examples, the current collectors are made of one or more materials selected from a group consisting of copper, stainless steel, brass, bronze, zinc, aluminum, and/or alloys thereof. External tabs 28 and 48 are connected to the current collectors of the cathode electrodes and anode electrodes, respectively, and can be arranged on the same or different sides of the battery cell stack 12. The external tabs 28 and 48 are connected to terminals of the battery cells.

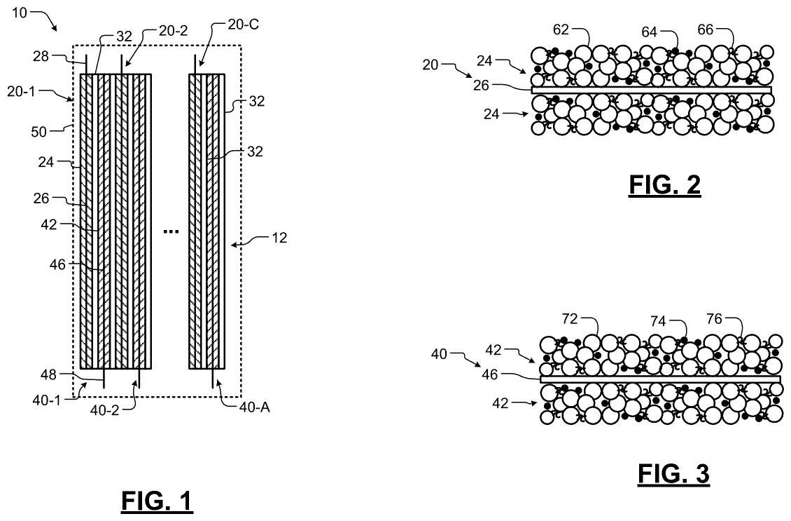

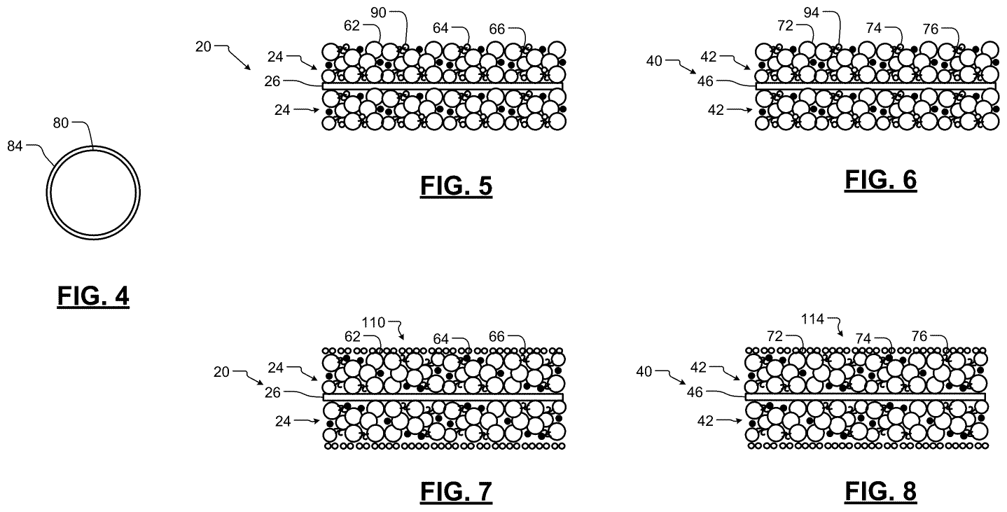

Referring now to FIGS. 2 and 3, examples of cathode electrodes and anode electrodes are shown. In FIG. 2, the cathode electrode 20 is shown in further detail. The cathode active material layer 24 of the cathode electrode 20 includes cathode active material 62 that is coated with a PTC material as shown in FIG. 4, an optional conductive additive 64, and an optional binder 66.

In FIG. 3, the anode electrode 40 is shown in further detail. The anode active material layer 42 of the anode electrode 40 includes anode active material 72 coated with a PTC material as shown in FIG. 4, an optional conductive additive 64, and an optional binder 66.

Referring now to FIG. 4, a particle 80 of the active material for a cathode electrode or an anode electrode is shown coated with a PTC coating 84. In some examples, the PTC coating 84 shuts down electronic pathways to the active material 80 at high temperatures in a range from 80° C. to 200° C. In some examples, the PTC coating 84 shuts down electronic pathways to the active material 80 at high temperatures in a range from 80° C. to 140° C. In some examples, a thickness of the PTC coating is in a range from 50 nm to 2 μm. In some examples, the thickness of the PTC coating is in the range from 200 nm to 500 nm.

Referring now to FIGS. 5 and 6, the cathode electrodes and/or anode electrodes can include PTC material mixed with other materials in the active material layer. In FIG. 5, the cathode electrode 20 includes the cathode active material layer 24 mixed with PTC particles 90.

In FIG. 6, the anode electrode 40 includes the anode active material layer 42 mixed with PTC particles 94. The PTC particles 90 and 94 act as conductive filler at lower temperatures when the battery cell temperature is under the Curie temperature (e.g., 120° C.). When the temperature of the battery cell increases above the Curie temperature, the PTC material 90 and 94 works as an electron blocker (due to the increased resistance) to shut down the battery cell and prevent further thermal issues. In some examples, the PTC particles 90 and 94 comprise 0.5% to 20 wt % of the active material layer. In some examples, the PTC particles comprise 1% to 5 wt % of the active material layer.

Referring now to FIGS. 7 and 8, a PTC layer can be used. In FIG. 7, the cathode electrode 20 includes a PTC layer 110 arranged between the cathode active material layer 24 and an adjacent separator. In FIG. 8, the anode electrode includes a PTC layer 114. The PTC layers 110 and/or 114 have significantly increased resistance at elevated temperatures to reduce or prevent short circuits. As can be appreciated, the cathode electrodes and/or anode electrodes may incorporate different combinations of the PTC material (e.g., the PTC coating of the active material, PTC particles in the active material, and/or the PTC layer between the active material and the adjacent separator).

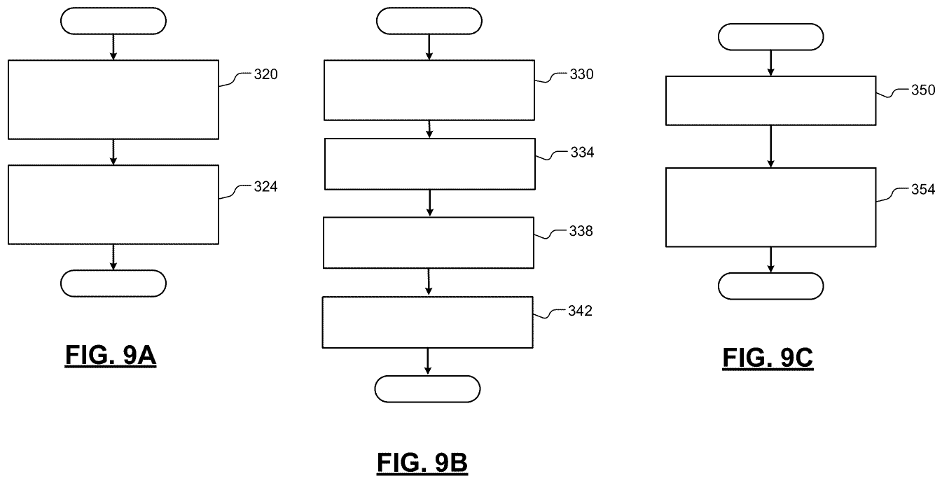

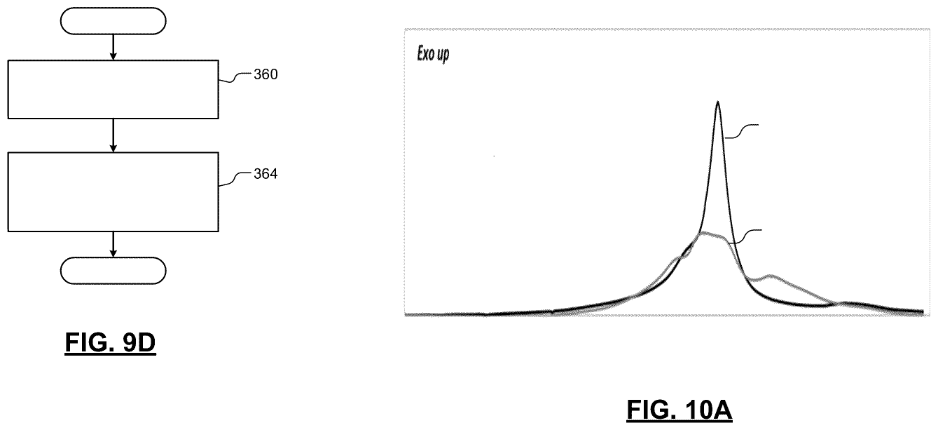

Referring now to FIG. 9A, a method for manufacturing an electrode including an active material layer including PTC particles is shown. At 320, a slurry including active material, binder and conductive filler is mixed with PTC particles. At 324, the mixture is printed or cast onto a current collector. For example, the mixture is printed using an intaglio printing machine or cast using a casting machine.

In FIG. 9B, a method for forming a PTC coating is shown. The method includes dissolving a PTC precursor in a solution (e.g., solvent-based, or aqueous) including active material particles at 330. The solution is heated for a predetermined period at 334 and then cooled. Solid particles are filtered at 338 and optionally rinsed. The particles are calcined at a predetermined temperature (e.g., 500° C. to 1000° C.) for a predetermined period at 342.

In FIG. 9C, a method for coating a PTC layer on an active material layer of an electrode is shown. The method includes mixing a slurry including a PTC material and a binder at 350. The mixture is printed or cast onto an active material layer of the electrode at 354. For example, an intaglio printing machine or casting machine can be used.

In FIG. 9D, another method for coating a PTC layer on particles of active material is shown. The active material and the PTC material are mixed at 360 and arranged in a mechanical fusion machine. The mechanical fusion machine mechanically presses the PTC material into the active material to create coated active material at 364.

In some examples, the active material layer of the electrode includes the active material in a range from 80 wt % to 99 wt %, the PTC material in a range from 0.5 wt % to 20 wt % (e.g., 1 wt % to 5 wt %), the conductive filler in a range from 0.5 wt % to 20 wt %, and the binder in a range from 0.5 wt % to 10 wt %. In some examples, loading of the electrode is in a range from 2 mAh/cm² to 10 mAh/cm². In some examples, loading of the electrode is in a range from 3 mAh/cm² to 6 mAh/cm².

In some examples, the PTC material includes an inorganic material selected from a group consisting of metal oxide, BaTiO₃, V₂O₅, and combinations thereof. In some examples, the PTC material further includes a doping element and/or an additive to adjust the Curie temperature. For example, the PTC material may include BaTiO₃ with a doping element (e.g., lanthanum (La), cerium (Ce), antimony (Sb), yttrium (Y), tungsten (W), titanium (Ti), tantalum (Ta), niobium (Nb), cobalt (Co), chlorine (Cl), iodine (I), bromine (Br)) and/or an additive (e.g., SiO₂, Al₂O₃). In some examples, the PTC material includes an organic material selected from a group consisting of polymethyl methacrylate (PMMA) or polydimethylsiloxane (PDMS). In some examples, the doping and/or additive are used to lower the Curie temperature of the PTC material below 150° C.

In some examples, the Curie temperature of the PTC material is in a range from 80° C. to 200° C. In some examples, the Curie temperature of the PTC material is less than 150° C. In some examples, the Curie temperature of the PTC material is in a range from 80° C. to 140° C.

In some examples, the cathode active material is selected from a group consisting of lithium nickel cobalt manganese (NCM), lithium nickel cobalt manganese aluminum (NCMA), lithium nickel cobalt aluminum oxide (NCA), lithium nickel manganese aluminum (NMA), nickel metal (NM), lithium nickel oxide (LNO), lithium iron phosphate (LFP), lithium manganese iron phosphate (MFMP), lithium cobalt oxide (LCO), and combinations thereof. In some examples, the morphology includes primary and secondary mono-sized particle type or bimodal type Ni-rich cathode. Is some examples, D50 is in a range from 1 μm to 20 μm. In some examples, the primary type is in a range from 3 μm to 6 μm and the secondary is in a range from 3 μm to 15 μm.

In some examples, the anode active material is selected from a group consisting of graphite, hard carbon, lithium silicon oxide (LSO), silicon (Si), and silicon oxide (SiOₓ). In some examples, the morphology of the Si-based material include nanoparticles, nanofibers, nanotubes, and microparticles. In some examples, the conductive filler is selected from a group consisting of graphite, graphene, carbon black, graphene oxide, Super P, acetylene black, carbon nanofibers, carbon nanotubes, and combinations thereof.

In some examples, the binder is selected from a group consisting of polyvinylidene difluoride (PVDF), polytetrafluoroethylene (PTFE), CMS, styrene butadiene rubber (SBR), polyacrylic acid (PAA), PAA-PHEA, and combinations thereof. In some examples, the PAA is neutralized by sodium hydroxide (NaOH) or lithium hydroxide (LiOH), sodium polyacrylate (PAANa), PAAH_{0.2}N_{0.8} or lithium polyacrylic acid (LiPAA).

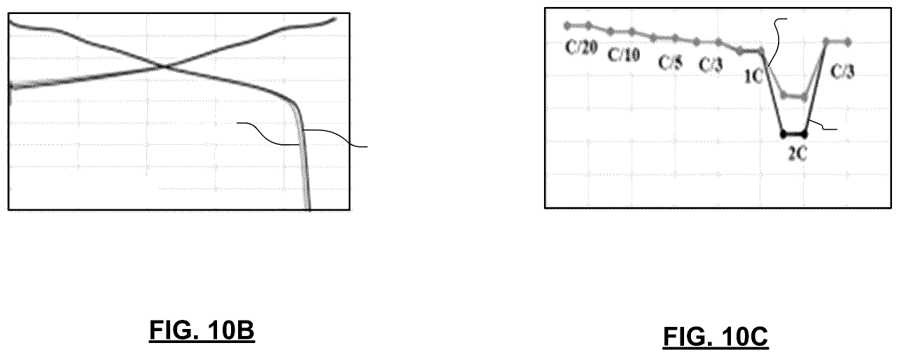

Referring now to FIG. 10A, a graph shows heat flow as a function of temperature for a battery cell with a cathode electrode including the PTC material as compared to the same battery cell without the PTC material. In this example, the cathode active material includes NCMA and the anode active material includes graphite. The cathode active material layer includes the cathode active material (e.g., NCMA), the PTC material, the conductive additive (e.g., Super P), and the binder (e.g., PVDF) with a ratio of 86/10/2/2 wt % (or 96/2/2 when PTC material is not used). The peak strength occurs at ˜220° C. is reduced from ˜15 W/g to ˜5 W/g.

Referring now to FIGS. 10B and 10C, a formation cycle check and capacity rate check of battery cells with and without PTC material are shown. The checks illustrate comparable performance of the battery cells with and without PTC material. In FIG. 10C, some of the active material was replaced by the PTC material which has higher conductivity and provides improved performance at some charging rates (e.g., 2C) and comparable performance at other charging rates.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. An electrode for a battery cell comprising:
a current collector; and
an active material layer arranged on the current collector comprising:
an active material;
a conductive additive;
a positive temperature coefficient (PTC) material; and
a binder.

2. The electrode of claim 1, wherein the active material is in a range from 80 wt % to 99 wt %, the PTC material is in a range from 0.5 wt % to 20 wt %, the conductive additive is in a range from 0.5 wt % to 20 wt %, and the binder is in a range from 0.5 wt % to 10 wt %.

3. The electrode of claim 1, wherein the active material is in a range from 80 wt % to 99 wt %, the PTC material is in a range from 1 wt % to 5 wt %, the conductive additive is in a range from 0.5 wt % to 20 wt %, and the binder is in a range from 0.5 wt % to 10 wt %.

4. The electrode of claim 1, wherein the PTC material has a Curie temperature in a range from 80° C. to 200° C.

5. The electrode of claim 1, wherein the PTC material has a Curie temperature in a range from 80° C. to 140° C.

6. The electrode of claim 1, wherein the PTC material includes an inorganic material selected from a group consisting of metal oxide, BaTiO₃, V₂O₅, and combinations thereof.

7. The electrode of claim 1, wherein the PTC material includes an organic material selected from a group consisting of polymethyl methacrylate (PMMA) or polydimethylsiloxane (PDMS).

8. The electrode of claim 1, wherein the PTC material is doped with one or more elements selected from a group consisting of lanthanum (La), cerium (Ce), antimony (Sb), yttrium (Y), tungsten (W), titanium (Ti), tantalum (Ta), niobium (Nb), cobalt (Co), chlorine (Cl), iodine (I), bromine (Br), and combinations thereof.

9. An electrode for a battery cell comprising:
a current collector; and
an active material layer arranged on the current collector comprising:
an active material including an outer coating layer comprising a positive temperature coefficient (PTC) material;
a conductive additive; and
a binder.

10. The electrode of claim 9, wherein the PTC material has a Curie temperature in a range from 80° C. to 200° C.

11. The electrode of claim 9, wherein the PTC material has a Curie temperature in a range from 80° C. to 140° C.

12. The electrode of claim 9, wherein the PTC material includes an inorganic material selected from a group consisting of metal oxide, BaTiO₃, V₂O₅, and combinations thereof.

13. The electrode of claim 9, wherein the PTC material includes an organic material selected from a group consisting of polymethyl methacrylate (PMMA) or polydimethylsiloxane (PDMS).

14. The electrode of claim 9, wherein the outer coating layer has a thickness in a range from 50 nm to 2 μm.

15. The electrode of claim 9, wherein the outer coating layer has a thickness in a range from 200 nm to 500 nm.

16. An electrode for a battery cell comprising:
a current collector;
an active material layer arranged on the current collector comprising:
an active material;
a conductive additive; and
a binder; and
a positive temperature coefficient (PTC) layer arranged on the active material layer comprising a PTC material.

17. The electrode of claim 16, wherein the PTC material has a Curie temperature in a range from 80° C. to 200° C.

18. The electrode of claim 16, wherein the PTC material has a Curie temperature in a range from 80° C. to 140° C.

19. The electrode of claim 16, wherein the PTC material includes an inorganic material selected from a group consisting of metal oxide, BaTiO₃, V₂O₅, and combinations thereof.

20. The electrode of claim 16, wherein the PTC material includes an organic material selected from a group consisting of polymethyl methacrylate (PMMA) or polydimethylsiloxane (PDMS).
